(19) United States
(12) Patent Application Publication
(10) Pub. No.: US 2024/0191945 A1
(43) Pub. Date: Jun. 13, 2024

(54) DEVICE FOR SQUEEZING AND DEHYDRATING REFINED COTTON

(71) Applicant: HUBEI JINHANJIANG REFINED COTTON CO., LTD, Zhongxiang (CN)

(72) Inventors: Hangxu ZHOU, Zhongxiang (CN); Zongqing FAN, Zhongxiang (CN); Jintao FAN, Zhongxiang (CN); Liwei LI, Zhongxiang (CN); Hongju ZHAN, Zhongxiang (CN)

(73) Assignee: HUBEI JINHANJIANG REFINED COTTON CO., LTD, Zhongxiang (CN)

(21) Appl. No.: 18/454,691

(22) Filed: Aug. 23, 2023

(30) Foreign Application Priority Data
Dec. 9, 2022 (CN) 202211576294.3

(51) Int. Cl. F26B 5/14

(52) U.S. Cl. CPC F26B 5/14

(57) ABSTRACT

A device for squeezing and dehydrating refined cotton is provided, the device includes a base, a dehydrating device body arranged on the base and a pre-dehydrating drum arranged on the dehydrating device body, wherein the dehydrating device body includes a dehydrating box body installed on the upper surface of the base and a dehydrating box cover fitting on the opening of the surface of the dehydrating box body, the pre-dehydrating drum is installed on and penetrates through the upper surface of the dehydrating box cover, a box-opening drive unit arranged on the base is used to drive the dehydrating box cover to move up and down; by ways of configuring a pre-dehydrating drum to cooperate with a pre-dehydrating plate and a laying-off baffle, a pre-dehydrating mechanism to operate with a squeezing and dehydrating mechanism, a pre-dehydrating board cooperates with the pre-dehydrating mechanism.

### CROSS-REFERENCE TO RELATED APPLICATIONS

This application claims priority to Chinese Application No. 202211576294.3, having a filing date of Dec. 9, 2022, the entire contents of which are hereby incorporated by reference.

### FIELD

The present invention relates to the technical field of refined cotton, in particular to a device for squeezing and dehydrating refined cotton.

### BACKGROUND

Refined cotton is of cotton cellulose material prepared by using a cotton linter as raw material to pass through the main processes such as opening, pretreatment, alkali treating, boiling, bleaching, squeezing and dehydrating, drying and so on, and mainly used to produce cellulose of ether, nitrification and acetate. Such material is widely applied in many fields such as food, medicine, chemicals for daily use, plastics, electronics, papermaking, metallurgy, aerospace and so on, known as a special industrial gourmet powder.

Squeezing and dehydrating is an important stage after the bleaching process, and functions mainly to raise drying efficiency and reduce heat energy needed for drying. At present, the devices for squeezing and dehydrating mostly take a mesh belt as conveyor and a pressure roller for squeezing and dehydrating, but such dehydration method cannot achieve complete dehydration, and the refined cotton done by squeezing and dehydrating still contains a large amount of water, therefore such dehydration method not only affects subsequent drying efficiency, but also makes against the control of energy consumption during drying.

### SUMMARY

The objective of the present invention is to achieve a good dehydration effect and conduce to subsequent rapid drying as well as the control of energy consumption during drying by providing a device for squeezing and dehydrating refined cotton.

In order to achieve the above object, the technical scheme adopted in the present invention is as follows:

A device for squeezing and dehydrating refined cotton, comprising a base, a dehydrating device body arranged on the base, a pre-dehydrating drum arranged on the dehydrating device body, a box-opening drive unit, a pre-dehydrating plate, a laying-off baffle, a pre-dehydrating mechanism, a material-supporting mechanism, a squeezing and dehydrating mechanism, a reflux tube, a vibration mechanism and a drain pipe,
the dehydrating device body includes a dehydrating box body installed on the upper surface of the base and a dehydrating box cover fitting on the opening of the surface of the dehydrating box body, and the pre-dehydrating drum is installed on and penetrates through the upper surface of the dehydrating box cover;
the box-opening drive unit is arranged on the base, used to drive the dehydrating box cover to move up and down, so that the dehydrating box cover takes material at the time of moving upwards and performs a squeezing and dehydrating operation at the time of moving downwards;
the pre-dehydrating plate and the laying-off baffle each are two in number and symmetrically arranged inside the pre-dehydrating drum, and the laying-off baffle is positioned below the pre-dehydrating plate;
the pre-dehydrating mechanism is arranged inside the pre-dehydrating drum to drive the two pre-dehydrating plates and the two laying-off baffles to move, the two pre-dehydrating plates relatively move close to and far away from each other to achieve pre-dehydrating and unloading materials, respectively, while the two laying-off baffles relatively move close to and far away from each other to achieve supporting materials and laying-off, respectively;
the material-supporting mechanism is arranged on the inner wall of the dehydrating box body, used to support the materials falling after the process via the pre-dehydrating drum;
the squeezing and dehydrating mechanism is arranged on the dehydrating box cover, used to squeeze and dehydrate the material falling into the material-supporting mechanism;
the reflux tube communicates with and is installed on the pre-dehydrating drum and the dehydrating box body;
the vibration mechanism is arranged on the dehydrating box body, used to vibrate the sewage squeezed by the squeezing and dehydrating mechanism and the sewage discharged from the reflux tube during the operation of the pre-dehydrating mechanism;
the drain pipe is installed on and penetrates through the dehydrating box body and a drain valve is installed on the drain pipe.

Due to the adoption of the scheme, by ways of configuring the pre-dehydrating drum to cooperate with the pre-dehydrating plate and the laying-off baffle, and the pre-dehydrating mechanism to operate with the squeezing and dehydrating mechanism, the pre-dehydrating board cooperates with the pre-dehydrating mechanism, so that the pre-dehydrating plate and the laying-off baffle can move alternately with each other to achieve the pre-dehydrating operation. Furthermore, the squeezing and dehydrating mechanism is configured to perform squeezing and dehydrating again, effectively enhancing the dehydration treatment effect of refined cotton materials. By ways of configuring the first wedge-shaped plate to cooperate with the third wedge-shaped plate, the pre-dehydrating plate can perform pre-dehydrating in motion; by ways of configuring the second wedge-shaped plate to cooperate with the fourth wedge-shaped plate, the laying-off baffle can perform laying-off in motion; and the first reciprocating screw is configured to rotate, so that the pre-dehydrating plate and the laying-off baffle can move alternately with each other to achieve the pre-dehydration operation, enabling the pre-dehydrating and the laying-off for materials to alternately progress, and effectively enhancing operation efficiency. Furthermore, the twin-shaft motor is configured to cooperate with the bevel gear, the first cylindrical gear, the second cylindrical gear, the third cylindrical gear and the fourth cylindrical gear, enabling the entire operation to realize multi-stage mechanized interaction. By ways of configuring the vibration mechanism to cooperate with the material supporting mechanism, the strainer can slide up and down by means of the sliding block, and cooperate with the cam in rotation to enable the strainer to repeatedly vibrate up and down, thereby effectively shaking the strainer to prevent the mesh holes from being blocked; furthermore, the strainer is configured to receive the sewage from filtrating and squeezing the sewage from pre-dehydrating, so as to avoid the impact coming from direct sewage discharge.

In the scheme, it should be noted that the twin-shaft motor is electrically connected to an external power source.

As a preferred embodiment, the box-opening drive unit includes a cylinder fixedly installed on the upper surface of the base and four longitudinal guiding rods installed at the four corner positions of the upper surface of the base, the piston rod of the cylinder is connected with the dehydrating box cover, the dehydrating box cover is slidably installed on the outer surface of the four longitudinal guiding rods, and a limit screw is set on the top of each longitudinal guiding rod by ways of threaded installation.

Due to the adoption of the scheme, the cylinder elongates to drive the dehydrating box cover to move upwards, so as to separate the dehydrating box cover from the dehydrating box body, thereby achieving taking materials. After taking materials, the cylinder contracts to drive the dehydrating box cover to move downwards, so as to shut the dehydrating box body with the dehydrating box cover, thereby achieving a squeezing and dehydrating operation. The longitudinal guiding rod can be used to guide and support the dehydrating box cover to move up and down, so that the dehydrating box cover has better stability and is not easy to disengage during upward and downward movement. The limit screw can restrict the dehydrating box cover, so as to avoid the dehydrating box cover from disengaging from the longitudinal guiding rod during the upward movement, furthermore to enable the limit screw to be unscrewed in case of needing the dehydrating box cover to be removed.

As a preferred embodiment, the pre-dehydrating plate is positioned inside the pre-dehydrating drum, two first transverse guiding rods are fixed on the side of the pre-dehydrating plate, the two first transverse guiding rods on the same side both slide through and extend from the pre-dehydrating drum, and are provided with a first connecting plate fixed and installed thereon, the side of the connecting plate is provided with a first wedge-shaped plate fixed and installed thereon, the lower surface of which has a first arc-shaped surface, the outside of the first transverse guiding rod is sleeved with a first spring having two ends respectively connected to the side of the pre-dehydrating drum and the side of the first connecting plate, the laying-off baffle is slidably installed on the inner wall of the slideway opened on the side of the pre-dehydrating drum, the side of the laying-off baffle is provided with a second connecting plate fixed thereon, two second transverse guiding rods are slidably installed on the second connecting plate, and one end of the second transverse guiding rod is installed on the side of the pre-dehydrating drum, while the other end of the second transverse guiding rod is provided with a first limit disk fixed and installed thereon, the outside of the second transverse guiding rod is sleeved with a second spring having two ends respectively connected to the second connecting plate and the first limit disk, and a second wedge-shaped plate misaligned with the first wedge-shaped plate is fixed on the side of the second connecting plate.

Due to the adoption of the scheme, the two pre-dehydrating plates cooperate with the first transverse guiding rod, so that the two pre-dehydrating plates have better stability in relative motion. The first spring is configured to drive the two pre-dehydrating plates to quickly return to their original positions and wait for next pre-dehydrating after their relative motion for pre-dehydrating. The two laying-off baffles cooperate with the second transverse guiding rod, so that when the two pre-dehydrating plates move relatively close to each other for pre-dehydrating, the two laying-off baffles are in a closed state to avoid materials from falling, and so that when the two pre-dehydrating plates move far away from each other, the two laying-off baffles can move relatively far away from each other under the action of the second transverse guiding rod to achieve unloading materials.

As a preferred embodiment, the pre-dehydrating mechanism includes a third connecting plate installed on the side of the pre-dehydrating drum, a first rotation shaft installed on the lower surface of the third connecting plate and the upper surface of the dehydrating box cover, a first reciprocating screw installed between two first rotation shafts, a moving plate threadedly installed on the outer surface of the first reciprocating screw, an installation plate installed on the side of the moving plate, a fourth wedge-shaped plate fixedly installed on the side of the installation plate and cooperating with the second wedge-shaped plate, and a third wedge-shaped plate fixedly installed on the side of the installation plate and cooperating with the first wedge-shaped plate, the upper surface of the third wedge-shaped plate has a second arc-shaped surface cooperating with the first arc-shaped surface, a third transverse guiding rod is fixed on the side of the third wedge plate, the other end of the third transverse guiding rod slidably passes through the installation plate and is provided with a second limit disk fixed thereon, the outside of the third transverse guiding rod is sleeved with a third spring having two ends respectively connected to the installation plate and the second limit disk, a first limit rod is fixed on the lower surface of the third connecting plate, and the moving plate is slidably installed on the outer surface of the first limit rod.

Due to the adoption of the scheme, the first rotation shaft rotates to drive the first reciprocating screw to rotate, and then drive the moving plate to move up and down, thereby driving the installation plate to move up and down. When the installation plate drives the third wedge-shaped plate and the fourth wedge-shaped plate to move down synchronously, the third wedge-shaped plate cooperates with the first wedge-shaped plate, enabling two first wedge-shaped plates to relatively move close to each other, so as to achieve the pre-dehydrating operation. When the installation plate continues to move downwards, the third wedge-shaped plate will separate from the first wedge-shaped plate, at this time the two pre-dehydrating plates will return to their original positions, meanwhile the fourth wedge-shaped plate will cooperate with the second wedge-shaped plate, driving two second wedge-shaped plates to relatively move far away from each other, so as to achieve the laying-off operation, at this time the installation plate has moved to the bottom. Then the installation plate moves upwards, at this time the fourth wedge-shaped plate separates from the second wedge-shaped plate, when the installation plate continues to move upwards, the second arc-shaped surface cooperates with the first arc-shaped surface, so as to enable the third wedge-shaped plate to move outwards to be misaligned with the first wedge-shaped plate, so that the first wedge-shaped plate does not hinder the upward movement of the third wedge-shaped plate. The third wedge-shaped plate moves upwards to the highest point, and then returns to its original position under the action of the third spring, so as to achieve the pre-dehydrating operation once.

As a preferred embodiment, the squeezing and dehydrating mechanism includes a twin-shaft motor fixed on the upper surface of the dehydrating box cover, two second rotation shafts rotationally installed on the dehydrating box cover, a first cylindrical gear and a third cylindrical gear respectively fixed installed on the ends of one output shaft of the twin-shaft motor and one of the two second rotation shafts and engaging with each other, a second reciprocating screw fixedly installed between the two second rotation shafts, a moving frame provided on the outer surface of the second reciprocating screw by ways of threaded installation, a third rotation shaft rotationally installed on the moving frame and a squeezing and dehydrating roller fixedly installed on the outer surface of the third rotation shaft, a second cylindrical gear is fixedly installed on the outer surface of the third rotation shaft, the inner wall of the dehydrating box body has a partition plate, a rack plate cooperating with the second cylindrical gear is fixedly installed on the surface of the partition plate, a reflux hole is opened on the partition plate, a second limit rod is fixedly installed on the inner wall of the dehydrating box cover, the moving frame is slidably installed on the outer surface of the second limit rod, and bevel gears engaging with each other are fixed on the other output shaft of the twin-shaft motor and the lower outer surface of the first rotation shaft.

Due to the adoption of the scheme, the twin-shaft motor cooperates with the two bevel gears to enable the first reciprocating screw to rotate, and then achieve the pre-dehydrating operation of materials. The first cylindrical gear and the third cylindrical gear engage with each other to enable the second rotation shaft to rotate, and then drive the second reciprocating screw to rotate, and the latter enables the moving frame to drive the squeezing and dehydrating roller to move backwards and forwards. Cooperating and engaging with the second cylindrical gear enables the squeezing and dehydrating roller to rotate, simultaneously moving backwards and forwards, so as to achieve the highly-efficient squeezing and dehydrating operation of materials. The second limit rod is configured to support and guide the moving frame, so that the moving frame has better stability in motion under the rotation of the second reciprocating screw.

As a preferred embodiment, the material-supporting mechanism includes a fixing frame fitting on the inner wall of the dehydrating box body, a connecting rod fixed on the upper surface of the fixing frame, a material-supporting plate installed at the top of the connecting rod, and a strainer slidably installed on the fixing frame, a bottom supporting block used to support the fixing frame is fixed at the four corners of the inner wall of the dehydrating box body, a top pressure rod used to press the material-supporting plate is fixedly installed on the inner wall of the dehydrating box cover, and a water leak hole and an operation hole are opened on the material-supporting plate.

Due to the adoption of the scheme, the bottom supporting plate cooperates with the top pressure rod, so as to effectively restrict the material-supporting mechanism. The material-supporting plate supports the material and cooperates with the squeezing and dehydrating roller to perform the squeezing and dehydrating operation. The strainer is used to filter the sewage coming from squeezing the material.

As a preferred embodiment, the vibration mechanism includes a fourth rotation shaft rotationally installed on the side of the dehydrating box body, a fourth cylindrical gear fixedly installed on the outer surface of the fourth rotation shaft and engaging with the third cylindrical gear, two fifth rotation shafts rotationally installed on the dehydrating box body, and three belt pulleys respectively fixed on the outer surface of the fourth rotation shaft and the outer surfaces of the two fifth rotation shafts, the three belt pulleys are connected with each other through a belt by ways of transmission, a cam is fixed on the outer surface of the fifth rotation shaft, and the outer surface of the cam fits on the lower surface of the installation frame of the strainer.

Due to the adoption of the scheme, the fourth cylindrical gear engages with the third cylindrical gear to enable the fourth rotation shaft to rotate, and the fifth rotation shaft to rotate under the transmission of the belt and the belt pulley, and then the cam to rotate. In this way, the installation frame drives the strainer to move up and down to enable the strainer to vibrate up and down, avoiding the mesh holes of the strainer from being blocked.

As a preferred embodiment, a plurality of sliding grooves are fixedly opened on the inner wall of the fixing frame, a sliding block is slidably installed on the inner wall of each sliding groove, a fourth spring is fixed on the inner wall of the sliding groove, and the top end of the fourth spring is connected to the sliding block, the identical installation frame is fixed between a plurality of sliding blocks, a fixing bolt is provided on the strainer by ways of threaded installation, and the tail of the fixing bolt passes through the strainer to connect with the installation frame.

Due to the adoption of the scheme, the sliding block slides in the sliding groove to cooperate with the fourth spring, so that the installation frame is always in stable contact with the cam, ensuring the smooth and orderly vibration operation of the strainer. The fixing bolt is cooperatively used to facilitate the disassembly and assembly of the strainer after the completion of the operation.

As a preferred embodiment, the connection point of the top end of the reflux tube with the pre-dehydrating drum is positioned in the middle of the two pre-dehydrating plates, and the connection point of the bottom end of the reflux tube with the dehydrating box body is positioned above the fixing frame and below the material-supporting plate.

Due to the adoption of the scheme, the reflux tube is configured to convey the sewage coming from the pre-dehydrating operation, so that the sewage coming from the pre-dehydrating operation and the sewage rising from the squeezing operation can be simultaneously filtered through the strainer.

As a preferred embodiment, a rubber sealing washer is stuck on the upper surface of the dehydrating box body, and the upper surface of the rubber sealing washer fits on the lower surface of the dehydrating box cover.

Due to the adoption of the scheme, an effective sealing connection between the dehydrating box body and the dehydrating box cover can be kept by means of the rubber sealing washer, ensuring good sealing characteristics and avoiding the sewage from overflowing from the fitting area between the two.

Compared with the prior art, the present invention has the following beneficial effects.

By ways of configuring the pre-dehydrating drum to cooperate with the pre-dehydrating plate and the laying-off baffle, and the pre-dehydrating mechanism to operate with the squeezing and dehydrating mechanism, the pre-dehydrating board cooperates with the pre-dehydrating mechanism, so that the pre-dehydrating plate and the laying-off baffle can move alternately with each other to achieve the pre-dehydrating operation. Furthermore, the squeezing and dehydrating mechanism is configured to perform squeezing and dehydrating again, effectively enhancing the dehydration treatment effect of refined cotton materials.

By ways of configuring the first wedge-shaped plate to cooperate with the third wedge-shaped plate, the pre-dehydrating plate can perform pre-dehydrating in motion; by ways of configuring the second wedge-shaped plate to cooperate with the fourth wedge-shaped plate, the laying-off baffle can perform laying-off in motion; and the first reciprocating screw is configured to rotate, so that the pre-dehydrating plate and the laying-off baffle can move alternately with each other to achieve the pre-dehydration operation, enabling the pre-dehydrating and the laying-off for materials to alternately progress, and effectively enhancing operation efficiency. Furthermore, the twin-shaft motor is configured to cooperate with the bevel gear, the first cylindrical gear, the second cylindrical gear, the third cylindrical gear and the fourth cylindrical gear, enabling the entire operation to realize multi-stage mechanized interaction.

By ways of configuring the vibration mechanism to cooperate with the material supporting mechanism, the strainer can slide up and down by means of the sliding block, and cooperate with the cam in rotation to enable the strainer to repeatedly vibrate up and down, thereby effectively shaking the strainer to prevent the mesh holes from being blocked; furthermore, the strainer is configured to receive the sewage from filtrating and squeezing the sewage from pre-dehydrating, so as to avoid the impact coming from direct sewage discharge.

### BRIEF DESCRIPTION OF THE DRAWINGS

FIG. 1 is a structure diagram of the present invention.

FIG. 2 is a structure diagram of the present invention at another angle of view.

FIG. 3 is a structure diagram of the dehydrating box body and the material-supporting mechanism according to the present invention.

FIG. 4 shows a cross section of the dehydrating box body and a structure diagram of the material-supporting mechanism according to the present invention.

FIG. 5 is a structure diagram of the dehydrating box body according to the present invention.

FIG. 6 is a structure diagram of the material-supporting mechanism according to the present invention.

FIG. 7 shows a cross section of the material-supporting mechanism according to the present invention.

FIG. 8 is a structure diagram of the dehydrating box cover and the pre-dehydrating drum according to the present invention.

FIG. 9 is a structure diagram of the dehydrating box cover according to the present invention.

FIG. 10 is a structure diagram of the dehydrating box cover according to the present invention at another angle of view.

FIG. 11 is a structure diagram of the pre-dehydrating drum according to the present invention.

FIG. 12 shows a cross section of the pre-dehydrating drum according to the present invention.

FIG. 13 is a structure diagram of the pre-dehydrating mechanism according to the present invention.

Where, 1—base; 2—dehydrating box body; 3—dehydrating box cover; 4—pre-dehydrating drum; 5—cylinder; 6—longitudinal guiding rod; 7—limit screw; 8—pre-dehydrating plate; 9—laying-off baffle; 10—pre-dehydrating mechanism; 11—squeezing and dehydrating mechanism; 12—vibration mechanism; 13—material-supporting mechanism; 14—drain pipe; 15—first transverse guiding rod; 16—connecting plate; 17—first spring; 18—first wedge-shaped plate; 19—second connecting plate; 20—second transverse guiding rod; 21—first limit disk; 22—second spring; 23—second wedge-shaped plate; 24—third connecting plate; 25—first rotation shaft; 26—first reciprocating screw; 27—moving plate; 28—installation plate; 29—third wedge-shaped plate; 30—fourth wedge-shaped plate; 31—third transverse guiding rod; 32—second limit disk; 33—third spring; 34—first limit rod; 35—bevel gear; 36—twin-shaft motor; 37—first cylindrical gear; 38—second rotation shaft; 39—second reciprocating screw; 40—moving frame; 41—second limit rod; 42—third rotation shaft; 43—the squeezing and dehydrating roller; 44—second cylindrical gear; 45—; 46—third cylindrical gear; 47—fourth rotation shaft; 48—fourth cylindrical gear; 49—fifth rotation shaft; 50—belt pulley; 51—belt; 52—cam; 53—bottom supporting plate; 54—fixing frame; 55—connecting rod; 56—material-supporting plate; 57—installation frame; 58—strainer; 59—fixing bolt; 60—sliding block; 61—fourth spring; 62—top pressure rod; 63—reflux tube; 64—partition plate; 65—reflux hole; 66—output shaft; 67—water leak hole; 68—operation hole; 69—sliding groove; 70—rubber sealing washer; 71—drain valve.

### DETAILED DESCRIPTION

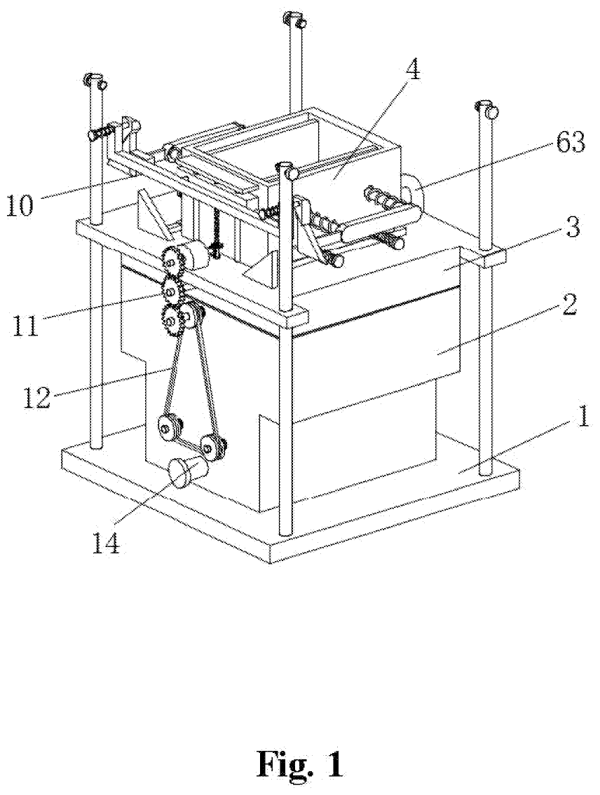

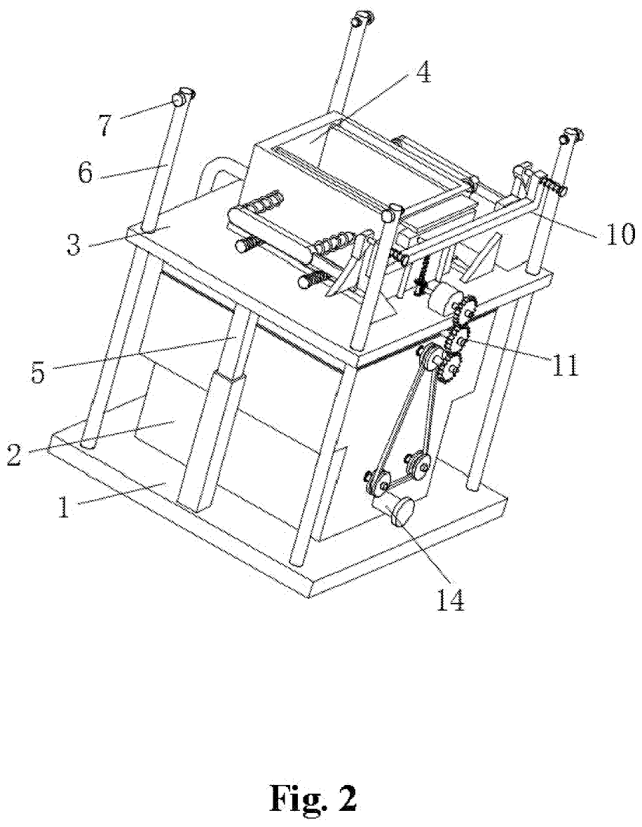

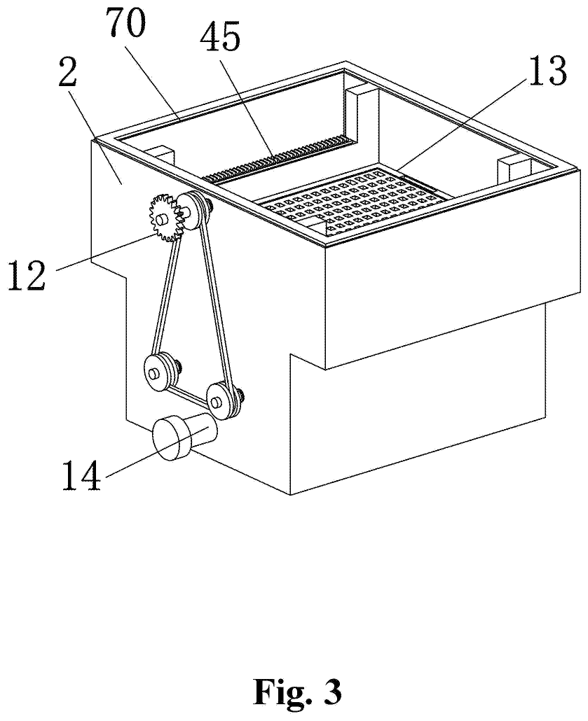

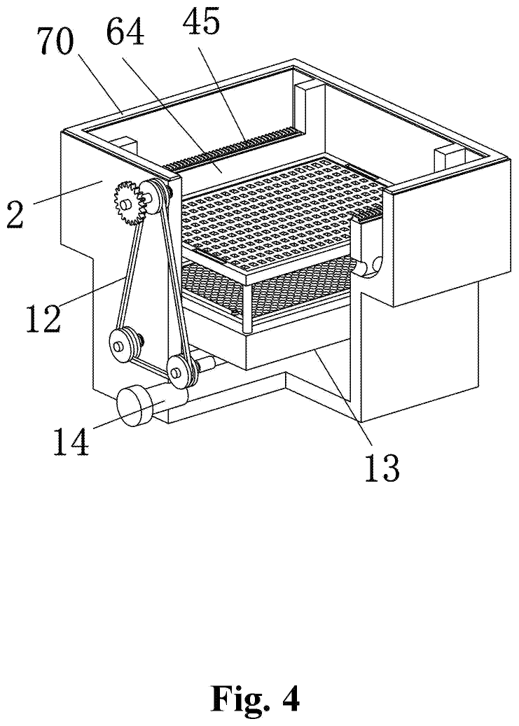

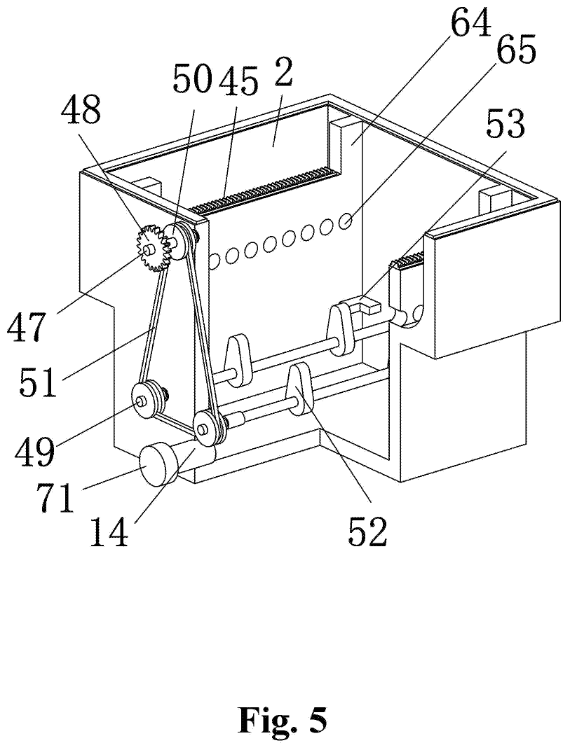

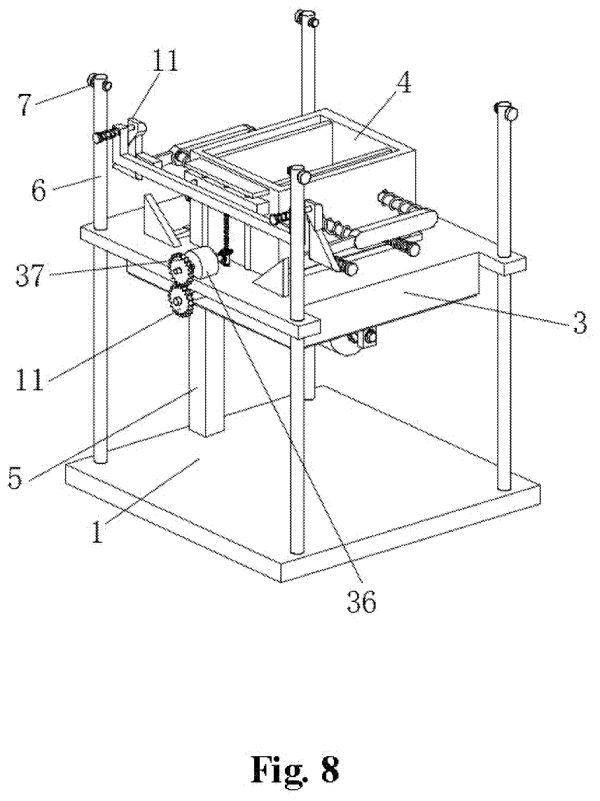

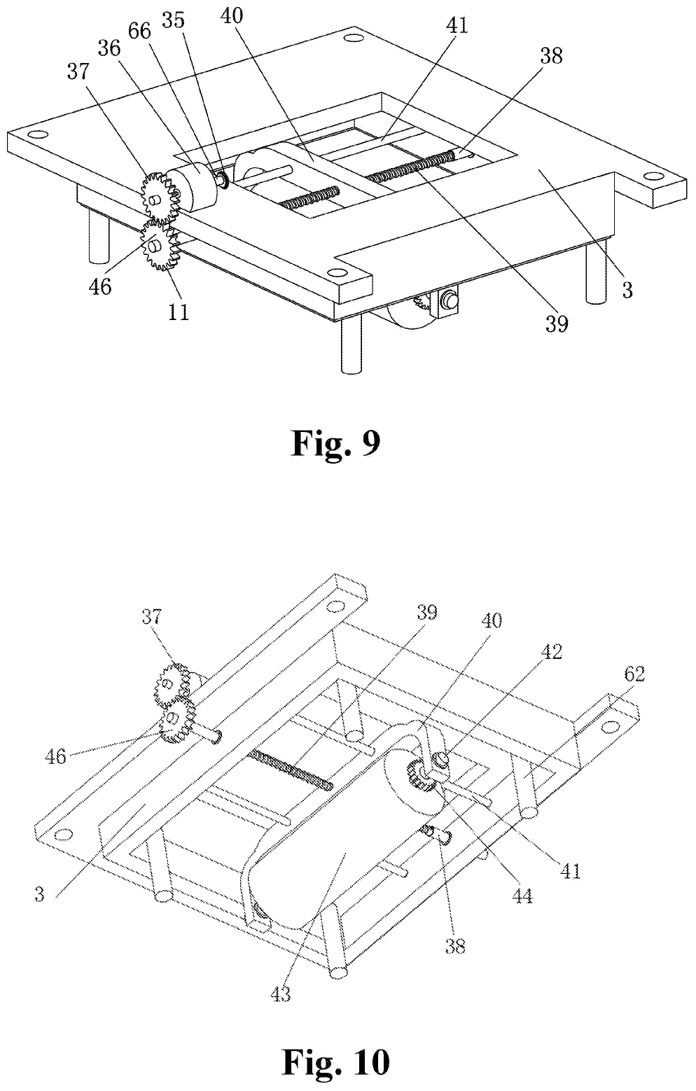

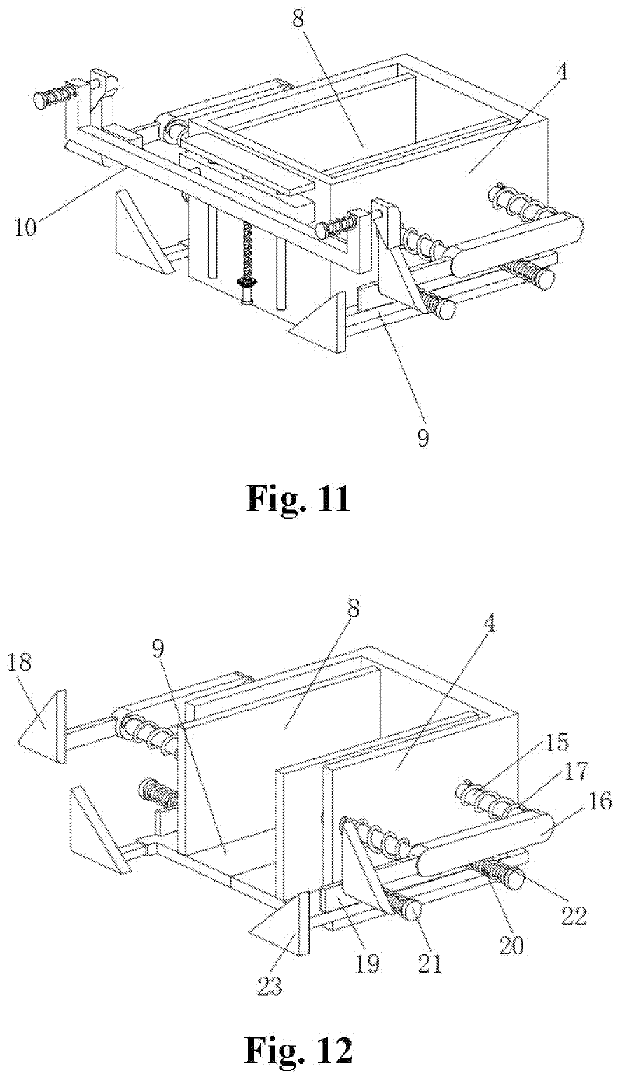

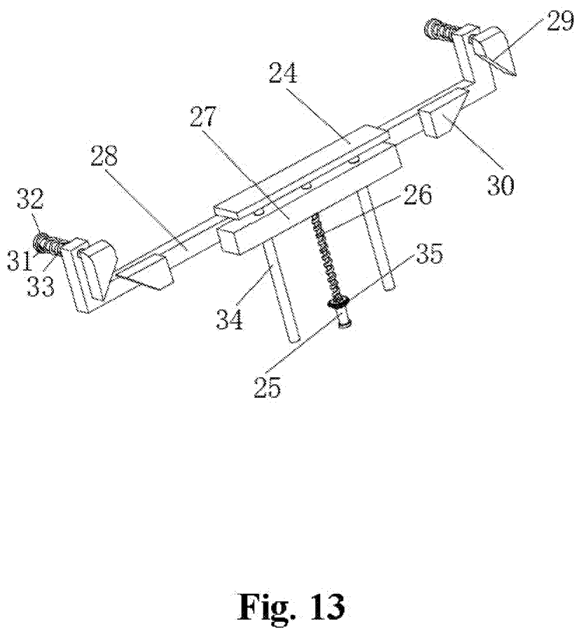

Referring to FIGS. 1-13, the present invention provides a device for squeezing and dehydrating refined cotton, which includes the base 1, a dehydrating device body arranged on the base 1 and the pre-dehydrating drum 4 arranged on the dehydrating device body, wherein the dehydrating device body includes the dehydrating box body 2 installed on the upper surface of the base 1 and the dehydrating box cover 3 fitting on the opening of the surface of the dehydrating box body 2, the pre-dehydrating drum 4 is installed on and penetrates through the upper surface of the dehydrating box cover 3, a rubber sealing washer 70 is stuck on the upper surface of the dehydrating box body 2, and the upper surface of the rubber sealing washer 70 fits on the lower surface of the dehydrating box cover 3, so that an effective sealing connection between the dehydrating box body 2 and the dehydrating box cover 3 can be kept by means of the rubber sealing washer 70, ensuring good sealing characteristics and avoiding the sewage from overflowing from the fitting area between the two.

A box-opening drive unit arranged on the base 1 is used to drive the dehydrating box cover 3 to move up and down, so that the dehydrating box cover 3 takes material at the time of moving upwards and performs a squeezing and dehydrating operation at the time of moving downwards. The box-opening drive unit includes the cylinder 5 fixedly installed on the upper surface of the base 1 and four longitudinal guiding rods 6 installed at the four corner positions of the upper surface of the base 1. The piston rod of the cylinder 5 is connected with the dehydrating box cover 3, the dehydrating box cover 3 is slidably installed on the outer surface of the four longitudinal guiding rods 6, and the limit screw 7 is set on the top of each longitudinal guiding rod 6 by ways of threaded installation. The cylinder 5 elongates to drive the dehydrating box cover 3 to move upwards, so as to separate the dehydrating box cover 3 from the dehydrating box body 2, thereby achieving taking materials. After taking materials, the cylinder 5 contracts to drive the dehydrating box cover 3 to move downwards, so as to shut the dehydrating box body 2 with the dehydrating box cover 3, thereby achieving a squeezing and dehydrating operation. The longitudinal guiding rod 6 can be used to guide and support the dehydrating box cover 3 to move up and down, so that the dehydrating box cover 3 has better stability and is not easy to disengage during upward and downward movement. The limit screw 7 can restrict the dehydrating box cover 3, so as to avoid the dehydrating box cover 3 from disengaging from the longitudinal guiding rod 6 during the upward movement, furthermore to enable the limit screw 7 to be unscrewed in case of needing the dehydrating box cover 3 to be removed.

The pre-dehydrating plate 8 and the laying-off baffle 9 each are two in number and symmetrically arranged inside the pre-dehydrating drum 4. The laying-off baffle 9 is positioned below the pre-dehydrating plate 8, the pre-dehydrating plate 8 is positioned inside the pre-dehydrating drum 4 and two first transverse guiding rods 15 are fixed on the side of the pre-dehydrating plate 8. The two first transverse guiding rods 15 on the same side both slide through and extend from the pre-dehydrating drum 4, and are provided with the first connecting plate 16 fixed and installed thereon. The side of the connecting plate 16 is provided with the first wedge-shaped plate 18 fixed and installed thereon, the lower surface of which has a first arc-shaped surface. The outside of the first transverse guiding rod 15 is sleeved with the first spring 17 having two ends respectively connected to the side of the pre-dehydrating drum 4 and the side of the first connecting plate 16. The laying-off baffle 9 is slidably installed on the inner wall of the slideway opened on the side of the pre-dehydrating drum 4, and the side of the laying-off baffle 9 is provided with the second connecting plate 19 fixed thereon. Two second transverse guiding rods 20 are slidably installed on the second connecting plate 19, and one end of the second transverse guiding rod 20 is installed on the side of the pre-dehydrating drum 4, while the other end of the second transverse guiding rod 20 is provided with the first limit disk 21 fixed and installed thereon. The outside of the second transverse guiding rod 20 is sleeved with the second spring 22 having two ends respectively connected to the second connecting plate 19 and the first limit disk 21. The second wedge-shaped plate 23 misaligned with the first wedge-shaped plate 18 is fixed on the side of the second connecting plate 19. The two pre-dehydrating plates 8 cooperate with the first transverse guiding rod 15, so that the two pre-dehydrating plates 8 have better stability in relative motion. The first spring 17 is configured to drive the two pre-dehydrating plates 8 to quickly return to their original positions and wait for next pre-dehydrating after their relative motion for pre-dehydrating. The two laying-off baffles 9 cooperate with the second transverse guiding rod 20, so that when the two pre-dehydrating plates 8 move relatively close to each other for pre-dehydrating, the two laying-off baffles 9 are in a closed state to avoid materials from falling, and so that when the two pre-dehydrating plates 8 move far away from each other, the two laying-off baffles 9 can move relatively far away from each other under the action of the second transverse guiding rod 20 to achieve unloading materials.

The pre-dehydrating mechanism 10 is arranged inside the pre-dehydrating drum 4 to drive the two pre-dehydrating plates 8 and the two laying-off baffles 9 to move. The two pre-dehydrating plates 8 relatively move close to and far away from each other to achieve pre-dehydrating and unloading materials, respectively, while the two laying-off baffles 9 relatively move close to and far away from each other to achieve supporting materials and laying-off, respectively. The pre-dehydrating mechanism 10 includes the third connecting plate 24 installed on the side of the pre-dehydrating drum 4, the first rotation shaft 25 installed on the lower surface of the third connecting plate 24 and the upper surface of the dehydrating box cover 3, the first reciprocating screw 26 installed between two first rotation shafts 25, the moving plate 27 threadedly installed on the outer surface of the first reciprocating screw 26, the installation plate 28 installed on the side of the moving plate 27, the fourth wedge-shaped plate 30 fixedly installed on the side of the installation plate 28 and cooperating with the second wedge-shaped plate 23, and the third wedge-shaped plate 29 fixedly installed on the side of the installation plate 28 and cooperating with the first wedge-shaped plate 18. The upper surface of the third wedge-shaped plate 29 has a second arc-shaped surface cooperating with the first arc-shaped surface, the third transverse guiding rod 31 is fixed on the side of the third wedge plate 29, the other end of the third transverse guiding rod 31 slidably passes through the installation plate 28 and is provided with the second limit disk 32 fixed thereon. The outside of the third transverse guiding rod 31 is sleeved with the third spring 33 having two ends respectively connected to the installation plate 28 and the second limit disk 32. The first limit rod 34 is fixed on the lower surface of the third connecting plate 24, and the moving plate 27 is slidably installed on the outer surface of the first limit rod 34. The first rotation shaft 25 rotates to drive the first reciprocating screw 26 to rotate, and then drive the moving plate 27 to move up and down, thereby driving the installation plate 28 to move up and down. When the installation plate 28 drives the third wedge-shaped plate 29 and the fourth wedge-shaped plate 30 to move down synchronously, the third wedge-shaped plate 29 cooperates with the first wedge-shaped plate 18, enabling two first wedge-shaped plates 18 to relatively move close to each other, so as to achieve the pre-dehydrating operation. When the installation plate 28 continues to move downwards, the third wedge-shaped plate 29 will separate from the first wedge-shaped plate 18, at this time the two pre-dehydrating plates 8 will return to their original positions, meanwhile the fourth wedge-shaped plate 30 will cooperate with the second wedge-shaped plate 23, driving two second wedge-shaped plates 23 to relatively move far away from each other, so as to achieve the laying-off operation, at this time the installation plate 28 has moved to the bottom. Then the installation plate 28 moves upwards, at this time the fourth wedge-shaped plate 30 separates from the second wedge-shaped plate 23, when the installation plate 28 continues to move upwards, the second arc-shaped surface cooperates with the first arc-shaped surface, so as to enable the third wedge-shaped plate 29 to move outwards to be misaligned with the first wedge-shaped plate 18, so that the first wedge-shaped plate 18 does not hinder the upward movement of the third wedge-shaped plate 29. The third wedge-shaped plate 29 moves upwards to the highest point, and then returns to its original position under the action of the third spring 33, so as to achieve the pre-dehydrating operation once.

The material-supporting mechanism 13 is arranged on the inner wall of the dehydrating box body 2, used to support the materials falling after the process via the pre-dehydrating drum 4. The material-supporting mechanism 13 includes the fixing frame 54 fitting on the inner wall of the dehydrating box body 2, the connecting rod 55 fixed on the upper surface of the fixing frame 54, the material-supporting plate 56 installed at the top of the connecting rod 55, and the strainer 58 slidably installed on the fixing frame 54. The bottom supporting block 53 used to support the fixing frame 54 is fixed at the four corners of the inner wall of the dehydrating box body 2, and the top pressure rod 62 used to press the material-supporting plate 56 is fixedly installed on the inner wall of the dehydrating box cover 3. A water leak hole 67 and an operation hole 68 are opened on the material-supporting plate 56. The bottom supporting plate 53 cooperates with the top pressure rod 62, so as to effectively restrict the material-supporting mechanism 13. The material-supporting plate 56 supports the material and cooperates with the squeezing and dehydrating roller 43 to perform the squeezing and dehydrating operation. The strainer 58 is used to filter the sewage coming from squeezing the material.

A plurality of sliding grooves 69 are fixedly opened on the inner wall of the fixing frame 54, and the sliding block 60 is slidably installed on the inner wall of each sliding groove 69. The fourth spring 61 is fixed on the inner wall of the sliding groove 69, and the top end of the fourth spring 61 is connected to the sliding block 60. The identical installation frame 57 is fixed between a plurality of sliding blocks 60. The fixing bolt 59 is provided on the strainer 58 by ways of threaded installation, and the tail of the fixing bolt 59 passes through the strainer 58 to connect with the installation frame 57. The sliding block 60 slides in the sliding groove 69 to cooperate with the fourth spring 61, so that the installation frame 57 is always in stable contact with the cam 52, ensuring the smooth and orderly vibration operation of the strainer 58. The fixing bolt 59 is cooperatively used to facilitate the disassembly and assembly of the strainer 58 after the completion of the operation.

The squeezing and dehydrating mechanism 11 is arranged on the dehydrating box cover 3, used to squeeze and dehydrate the material falling into the material-supporting mechanism 13. The squeezing and dehydrating mechanism 11 includes the twin-shaft motor 36 fixed on the upper surface of the dehydrating box cover 3, two second rotation shafts 38 rotationally installed on the dehydrating box cover 3, the first cylindrical gear 37 and third cylindrical gear 46 respectively fixed installed on the ends of one output shaft of the twin-shaft motor 36 and one of the two second rotation shafts 38 and engaging with each other, the second reciprocating screw 39 fixedly installed between the two second rotation shafts 38, the moving frame 40 provided on the outer surface of the second reciprocating screw 39 by ways of threaded installation, the third rotation shaft 42 rotationally installed on the moving frame 40 and the squeezing and dehydrating roller 43 fixedly installed on the outer surface of the third rotation shaft 42. The second cylindrical gear 44 is fixedly installed on the outer surface of the third rotation shaft 42, the inner wall of the dehydrating box body 2 has a partition plate 64, the rack plate 45 cooperating with the second cylindrical gear 44 is fixedly installed on the surface of the partition plate 64, a reflux hole 65 is opened on the partition plate 64. The second limit rod 41 is fixedly installed on the inner wall of the dehydrating box cover 3, and the moving frame 40 is slidably installed on the outer surface of the second limit rod 41. The bevel gears 35 engaging with each other are fixed on the other output shaft 66 of the twin-shaft motor 36 and the lower outer surface of the first rotation shaft 25. The twin-shaft motor 36 cooperates with the two bevel gears 35 to enable the first reciprocating screw 26 to rotate, and then achieve the pre-dehydrating operation of materials. The first cylindrical gear 37 and the third cylindrical gear 46 engage with each other to enable the second rotation shaft 38 to rotate, and then drive the second reciprocating screw 39 to rotate, and the latter enables the moving frame 40 to drive the squeezing and dehydrating roller 43 to move backwards and forwards. Cooperating and engaging with the second cylindrical gear 44 enables the squeezing and dehydrating roller 43 to rotate, simultaneously moving backwards and forwards, so as to achieve the highly-efficient squeezing and dehydrating operation of materials. The second limit rod 41 is configured to support and guide the moving frame 40, so that the moving frame 40 has better stability in motion under the rotation of the second reciprocating screw 39.

The reflux tube 63 communicates with and is installed on the pre-dehydrating drum 4 and the dehydrating box body 2. The connection point of the top end of the reflux tube 63 with the pre-dehydrating drum 4 is positioned in the middle of the two pre-dehydrating plates 8. The connection point of the bottom end of the reflux tube 63 with the dehydrating box body 2 is positioned above the fixing frame 54 and below the material-supporting plate 56. The reflux tube 63 is configured to convey the sewage coming from the pre-dehydrating operation, so that the sewage coming from the pre-dehydrating operation and the sewage rising from the squeezing operation can be simultaneously filtered through the strainer 58.

The vibration mechanism 12 is arranged on the dehydrating box body 2, used to vibrate the sewage squeezed by the squeezing and dehydrating mechanism 11 and the sewage discharged from the reflux tube 63 during the operation of the pre-dehydrating mechanism 10. The vibration mechanism 12 includes the fourth rotation shaft 47 rotationally installed on the side of the dehydrating box body 2, the fourth cylindrical gear 48 fixedly installed on the outer surface of the fourth rotation shaft 47 and engaging with the third cylindrical gear 46, two fifth rotation shafts 49 rotationally installed on the dehydrating box body 2, and three belt pulleys respectively fixed on the outer surface of the fourth rotation shaft 47 and the outer surfaces of the two fifth rotation shafts 49. The three belt pulleys 50 are connected with each other through the belt 51 by ways of transmission, the cam 52 is fixed on the outer surface of the fifth rotation shaft 49, the outer surface of the cam 52 fits on the lower surface of the installation frame 57 of the strainer 58. The fourth cylindrical gear 48 engages with the third cylindrical gear 46 to enable the fourth rotation shaft 47 to rotate, and the fifth rotation shaft 49 to rotate under the transmission of the belt 51 and the belt pulley 50, and then the cam 52 to rotate. In this way, the installation frame 57 drives the strainer 58 to move up and down to enable the strainer 58 to vibrate up and down, avoiding the mesh holes of the strainer 58 from being blocked.

The drain pipe 14 is installed on and penetrates through the dehydrating box body 2 and a drain valve 71 is installed on the drain pipe 14.

During use, firstly feeding the refined cotton material to be treated into the pre-dehydration drum 4, then starting the twin-shaft motor 36, so that the twin-shaft motor 36 drives the first rotation shaft 25 to rotate under the action of the two bevel gears 35 engaging with each other, and the first rotation shaft 25 rotates to drive the first reciprocating screw 26 to rotate, thus the latter drives the moving plate 27 to move up and down, thereby driving the installation plate 28 to move up and down. When the installation plate 28 drives the third wedge-shaped plate 29 and the fourth wedge-shaped plate 30 to move downwards synchronously, the third wedge-shaped plate 29 cooperates with the first wedge-shaped plate 18, enabling two first wedge-shaped plates 18 to relatively move close to each other, so as to achieve the pre-dehydrating operation. When the installation plate 28 continues to move downwards, the third wedge-shaped plate 29 will separate from the first wedge-shaped plate 18, at this time the two pre-dehydrating plates 8 will return to their original positions, meanwhile the fourth wedge-shaped plate 30 will cooperate with the second wedge-shaped plate 23, driving two second wedge-shaped plates 23 to relatively move far away from each other, so as to achieve the laying-off operation, at this time the installation plate 28 has moved to the bottom. Then the installation plate 28 moves upwards, at this time the fourth wedge-shaped plate 30 separates from the second wedge-shaped plate 23, when the installation plate 28 continues to move upwards, the second arc-shaped surface cooperates with the first arc-shaped surface, so as to enable the third wedge-shaped plate 29 to move outwards to be misaligned with the first wedge-shaped plate 18, so that the first wedge-shaped plate 18 does not hinder the upward movement of the third wedge-shaped plate 29. The third wedge-shaped plate 29 moves upwards to the highest point, and then returns to its original position under the action of the third spring 33, so as to achieve the pre-dehydrating operation once. The sewage coming from the pre-dehydrating operation is conveyed to the upper part of the strainer 58 inside the dehydrating box body 2 via the reflux tube 63, and the material coming from laying-off baffle 9 falls on the upper part of the material-supporting plate 56. At the same time, the first cylindrical gear 37 and the third cylindrical gear 36 engage with each other, enabling the second rotation shaft 38 to drive the second reciprocating screw 39 to rotate, and then the latter enables the moving frame 40 to drive the squeezing and dehydrating roller 43 to move backwards and forwards. Cooperating and engaging with the second cylindrical gear 44 enables the squeezing and dehydrating roller 43 to rotate, simultaneously moving backwards and forwards, so as to achieve the highly-efficient squeezing and dehydrating operation of materials. The sewage coming from the squeezing operation also falls on the upper part of the strainer 58, then the strainer 58 filters and segregates the sewage, at the same time, the fourth cylindrical gear engages with the third cylindrical gear 46 to enable the fourth rotation shaft 47 to rotate, and the fifth rotation shaft 49 to rotate under the transmission of the belt 51 and the belt pulley 50, and then the cam 52 to rotate. In this way, the installation frame 57 drives the strainer 58 to move up and down to enable the strainer 58 to vibrate up and down, avoiding the mesh holes of the strainer 58 from being blocked. The cylinder 5 elongates to drive the dehydrating box cover 3 to move upwards at the time of taking materials after finishing the operation, so as to separate the dehydrating box cover 3 from the dehydrating box body 2, then just pulling the material-supporting mechanism 13 up enables taking materials.

What is claimed is:

1. A device for squeezing and dehydrating refined cotton, comprising a base (1), a dehydrating device body arranged on said base (1), a pre-dehydrating drum (4) arranged on said dehydrating device body, a box-opening drive unit, a pre-dehydrating plate (8), a laying-off baffle (9), a pre-dehydrating mechanism (10), a material-supporting mechanism (13), a squeezing and dehydrating mechanism (11), a reflux tube (63), a vibration mechanism (12) and a drain pipe (14),
wherein said dehydrating device body includes a dehydrating box body (2) installed on an upper surface of said base (1) and a dehydrating box cover (3) fitting on an opening of a surface of the dehydrating box body (2), and said pre-dehydrating drum (4) is installed on and penetrates through an upper surface of the dehydrating box cover (3);
wherein said box-opening drive unit is arranged on said base (1), used to drive said dehydrating box cover (3) to move up and down, so that said dehydrating box cover (3) takes material at a time of moving upwards and performs a squeezing and dehydrating operation at a time of moving downwards;
wherein said pre-dehydrating plate (8) and said laying-off baffle (9) each are two in number and symmetrically arranged inside said pre-dehydrating drum (4), and said laying-off baffle (9) is positioned below said pre-dehydrating plate (8);
wherein said pre-dehydrating mechanism (10) is arranged inside said pre-dehydrating drum (4) to drive said two pre-dehydrating plates (8) and said two laying-off baffles (9) to move, said two pre-dehydrating plates (8) relatively move close to and far away from each other to achieve pre-dehydrating and unloading materials, respectively, while said two laying-off baffles (9) relatively move close to and far away from each other to achieve supporting materials and laying-off, respectively;
wherein said material-supporting mechanism (13) is arranged on an inner wall of said dehydrating box body (2), used to support the materials falling after a process via said pre-dehydrating drum (4);
wherein said squeezing and dehydrating mechanism (11) is arranged on said dehydrating box cover (3), used to squeeze and dehydrate the materials falling into said material-supporting mechanism (13);
wherein said reflux tube (63) communicates with and is installed on said pre-dehydrating drum (4) and said dehydrating box body (2);
wherein said vibration mechanism (12) is arranged on said dehydrating box body (2), used to vibrate a sewage squeezed by the squeezing and dehydrating mechanism (11) and the sewage discharged from said reflux tube (63) during an operation of said pre-dehydrating mechanism (10);
wherein said drain pipe (14) is installed on and penetrates through said dehydrating box body (2) and a drain valve (71) is installed on said drain pipe (14).

2. The device for squeezing and dehydrating refined cotton according to claim 1, wherein said box-opening drive unit includes a cylinder (5) fixedly installed on the upper surface of said base (1) and four longitudinal guiding rods (6) installed at the four corner positions of the upper surface of said base (1), a piston rod of the cylinder (5) is connected with said dehydrating box cover (3), said dehydrating box cover (3) is slidably installed on an outer surface of the four longitudinal guiding rods (6), and a limit screw (7) is set on a top of each longitudinal guiding rod (6) by ways of threaded installation.

3. The device for squeezing and dehydrating refined cotton according to claim 1, wherein said pre-dehydrating plate (8) is positioned inside said pre-dehydrating drum (4), two first transverse guiding rods (15) are fixed on a side of said pre-dehydrating plate (8), the two first transverse guiding rods (15) on the same side both slide through and extend from said pre-dehydrating drum (4), and are provided with a first connecting plate (16) fixed and installed thereon, a side of the connecting plate (16) is provided with a first wedge-shaped plate (18) fixed and installed thereon, a lower surface of which has a first arc-shaped surface, an outside of the first transverse guiding rod (15) is sleeved with a first spring (17) having two ends respectively connected to a side of said pre-dehydrating drum (4) and the side of the first connecting plate (16), said laying-off baffle (9) is slidably installed on an inner wall of a slideway opened on the side of said pre-dehydrating drum (4), the side of said laying-off baffle (9) is provided with a second connecting plate (19) fixed thereon, two second transverse guiding rods (20) are slidably installed on the second connecting plate (19), and one end of the second transverse guiding rod (20) is installed on the side of said pre-dehydrating drum (4), while the other end of the second transverse guiding rod (20) is provided with a first limit disk (21) fixed and installed thereon, an outside of the second transverse guiding rod (20) is sleeved with a second spring (22) having two ends respectively connected to the second connecting plate (19) and the first limit disk (21), and a second wedge-shaped plate (23) misaligned with the first wedge-shaped plate (18) is fixed on a side of the second connecting plate (19).

4. The device for squeezing and dehydrating refined cotton according to claim 3, wherein said pre-dehydrating mechanism (10) includes a third connecting plate (24) installed on the side of said pre-dehydrating drum (4), a first rotation shaft (25) installed on a lower surface of the third connecting plate (24) and the upper surface of said dehydrating box cover (3), a first reciprocating screw (26) installed between two first rotation shafts (25), a moving plate (27) threadedly installed on an outer surface of the first reciprocating screw (26), an installation plate (28) installed on a side of the moving plate (27), a fourth wedge-shaped plate (30) fixedly installed on a side of the installation plate (28) and cooperating with the second wedge-shaped plate (23), and a third wedge-shaped plate (29) fixedly installed on the side of the installation plate (28) and cooperating with the first wedge-shaped plate (18), an upper surface of the third wedge-shaped plate (29) has a second arc-shaped surface cooperating with the first arc-shaped surface, a third transverse guiding rod (31) is fixed on a side of the third wedge plate (29), an end of the third transverse guiding rod (31) slidably passes through the installation plate (28) and is provided with a second limit disk (32) fixed thereon, an outside of the third transverse guiding rod (31) is sleeved with a third spring (33) having two ends respectively connected to the installation plate (28) and the second limit disk (32), a first limit rod (34) is fixed on the lower surface of the third connecting plate (24), and the moving plate (27) is slidably installed on an outer surface of the first limit rod (34).

5. The device for squeezing and dehydrating refined cotton according to claim 4, wherein said squeezing and dehydrating mechanism (11) includes a twin-shaft motor (36) fixed on the upper surface of said dehydrating box cover (3), two second rotation shafts (38) rotationally installed on said dehydrating box cover (3), a first cylindrical gear (37) and a third cylindrical gear (46) respectively fixed installed on ends of one output shaft of the twin-shaft motor (36) and one of the two second rotation shafts (38) and engaging with each other, a second reciprocating screw (39) fixedly installed between the two second rotation shafts (38), a moving frame (40) provided on an outer surface of the second reciprocating screw (39) by ways of threaded installation, a third rotation shaft (42) rotationally installed on the moving frame (40) and a squeezing and dehydrating roller (43) fixedly installed on an outer surface of the third rotation shaft (42), a second cylindrical gear (44) is fixedly installed on the outer surface of the third rotation shaft (42), the inner wall of said dehydrating box body (2) has a partition plate (64), a rack plate (45) cooperating with the second cylindrical gear (44) is fixedly installed on a surface of the partition plate (64), a reflux hole (65) is opened on the partition plate (64), a second limit rod (41) is fixedly installed on the inner wall of said dehydrating box cover (3), the moving frame (40) is slidably installed on an outer surface of the second limit rod (41), and bevel gears (35) engaging with each other are fixed on the other output shaft (66) of the twin-shaft motor (36) and a lower outer surface of the first rotation shaft (25).

6. The device for squeezing and dehydrating refined cotton according to claim 5, wherein said material-supporting mechanism (13) includes a fixing frame (54) fitting on the inner wall of said dehydrating box body (2), a connecting rod (55) fixed on an upper surface of the fixing frame (54), a material-supporting plate (56) installed at a top of the connecting rod (55), and a strainer (58) slidably installed on the fixing frame (54), a bottom supporting block (53) used to support the fixing frame (54) is fixed at four corners of the inner wall of said dehydrating box body (2), a top pressure rod (62) used to press the material-supporting plate (56) is fixedly installed on the inner wall of said dehydrating box cover (3), and a water leak hole (67) and an operation hole (68) are opened on the material-supporting plate (56).

7. The device for squeezing and dehydrating refined cotton according to claim 6, wherein said vibration mechanism (12) includes a fourth rotation shaft (47) rotationally installed on the side of said dehydrating box body (2), a fourth cylindrical gear (48) fixedly installed on an outer surface of the fourth rotation shaft (47) and engaging with the third cylindrical gear (46), two fifth rotation shafts (49) rotationally installed on said dehydrating box body (2), and three belt pulleys (50) respectively fixed on the outer surface of the fourth rotation shaft (47) and outer surfaces of the two fifth rotation shafts (49), the three belt pulleys (50) are connected with each other through a belt (51) by ways of transmission, a cam (52) is fixed on the outer surface of the fifth rotation shaft (49), and the outer surface of the cam (52) fits on the lower surface of the installation frame (57) of the strainer (58).

8. The device for squeezing and dehydrating refined cotton according to claim 6, wherein a plurality of sliding grooves (69) are fixedly opened on an inner wall of the fixing frame (54), a sliding block (60) is slidably installed on an inner wall of each sliding groove (69), a fourth spring (61) is fixed on the inner wall of the sliding groove (69), and a top end of the fourth spring (61) is connected to the sliding block (60), the identical installation frame (57) is fixed between a plurality of sliding blocks (60), a fixing bolt (59) is provided on the strainer (58) by ways of threaded installation, and a tail of the fixing bolt (59) passes through the strainer (58) to connect with the installation frame (57).

9. The device for squeezing and dehydrating refined cotton according to claim 7, wherein a connection point of a top end of said reflux tube (63) with said pre-dehydrating drum (4) is positioned in a middle of the two pre-dehydrating plates (8), and a connection point of a bottom end of said reflux tube (63) with said dehydrating box body (2) is positioned above the fixing frame (54) and below the material-supporting plate (56).

10. The device for squeezing and dehydrating refined cotton according to claim 1, wherein a rubber sealing washer (70) is stuck on an upper surface of said dehydrating box body (2), and an upper surface of the rubber sealing washer (70) fits on a lower surface of said dehydrating box cover (3).
